(19) United States
(12) Patent Application Publication
(10) Pub. No.: US 2018/0220278 A1
(43) Pub. Date: Aug. 2, 2018

(54) SYSTEM AND METHOD FOR SECURING AND VERIFYING INFORMATION FROM TRANSPORTATION MONITORS

(71) Applicant: BRIEFTRACE LTD., Herzliya (IL)

(72) Inventors: Nir TAL, Haifa (IL); Tal MESHULAM, Tel Aviv (IL); Eyal KAMIR, Netanya (IL); Tal BEN-PORATH, Tel Aviv (IL); Tamir DAVID-HAY, Raanana (IL)

(21) Appl. No.: 15/884,669

(22) Filed: Jan. 31, 2018

Related U.S. Application Data
(60) Provisional application No. 62/589,728, filed on Nov. 22, 2017.
(60) Provisional application No. 62/586,372, filed on Nov. 15, 2017.
(60) Provisional application No. 62/572,608, filed on Oct. 16, 2017.
(60) Provisional application No. 62/554,107, filed on Sep. 5, 2017.
(60) Provisional application No. 62/536,035, filed on Jul. 24, 2017.
(60) Provisional application No. 62/512,093, filed on May 29, 2017.
(60) Provisional application No. 62/512,089, filed on May 29, 2017.
(60) Provisional application No. 62/453,049, filed on Feb. 1, 2017.

(51) Int. Cl. H04W 4/38; G06Q 10/08; H04L 29/08; G06Q 20/36; G06Q 20/38; G06F 17/30

(52) U.S. Cl. CPC H04W 4/38; G06Q 10/0833; H04L 67/125; H04L 2209/38; G06Q 20/3823; G06F 17/30185; G06Q 20/36

(57) ABSTRACT

A system and method for sending sensor information from a device may include reading, by a controller in the device, sensor information from a sensor; generating, by the controller, a blockchain message based on the sensor information; signing, by the controller, the blockchain message and sending, by the controller, the blockchain message to a blockchain node connected to a blockchain network and adding, based on the blockchain message, a block to a blockchain database, by a blockchain miner node connected to the blockchain network.

### CROSS-REFERENCE TO RELATED APPLICATIONS

This application claims the benefit of U.S. Provisional Patent Application No. 62/453,049, entitled “SYSTEM AN METHOD VALIDATING SENSOR INPUT”, filed on Feb. 1, 2017. This application claims the benefit of U.S. Provisional Patent Application No. 62/512,089 entitled “SYSTEM AND METHOD FOR TRACKING A UNIT LOAD DEVICE”, filed on May 29, 2017. This application claims the benefit of U.S. Provisional Patent Application No. 62/512,093 entitled “SYSTEM AND METHOD FOR TRACKING A SHIPMENT”, filed on May 29, 2017. This application claims the benefit of U.S. Provisional Patent Application No. 62/536,035, entitled “METHOD AND APPARATUS FOR TRACKER BASED QUALITY METRIC ESTIMATION IN PACKAGE TRACKING”, filed on Jul. 24, 2017. This application claims the benefit of U.S. Provisional Patent Application No. 62/554,107, entitled “APPARATUS, METHOD AND SYSTEM FOR TRACKING TEMPERATURE AND POSITION INFORMATION FROM MULTIPLE CONTAINERS AND TRANSMITTING IT OVER A WIRELESS NETWORK”, filed on Sep. 5, 2017. This application claims the benefit of U.S. Provisional Patent Application No. 62/572,608, entitled “APPARATUS, METHOD AND SYSTEM FOR SECURING AND VERIFYING INFORMATION FROM TRANSPORTATION MONITORS”, filed on Oct. 16, 2017. This application claims the benefit of U.S. Provisional Patent Application No. 62/586,372, entitled “SYSTEM, METHOD AND APPARATUS FOR SENDING, VALIDATING AND RETRIEVING INFORMATION USING BLOCK CHAIN”, filed on Nov. 15, 2017. This application claims the benefit of U.S. Provisional Patent Application No. 62/589,728, entitled “APPARATUS, METHOD AND SYSTEM FOR SECURING AND VERIFYING INDOORS LOCATION INFORMATION FROM TRANSPORTATION MONITORS”, filed on Nov. 22, 2017. The entire content of all of these applications is incorporated herein by reference.

### FIELD OF THE INVENTION

The present invention relates to the field of shipment tracking and more particularly monitoring temperature of shipped goods and logging and authentication data related to a shipment using blockchain technology.

### BACKGROUND OF THE INVENTION

In the field of goods transportation or shipment, it is common today to use trackers or loggers in order to track the whereabouts of shipped goods and/or log conditions that may affect shipped goods, e.g., temperature, humidity or light exposure. Generally, loggers or monitors are observation units that provide a user with real time or other critical information about a shipment. Since mishandling of a shipment can cause significant financial loss to one of the parties involved, there is an incentive to protect data and records related to a shipment from forgery or falsification of tracker's records.

### SUMMARY OF THE INVENTION

In some embodiments, a method of enabling verification of a telemetry packet includes generating, by a controller in a device, a telemetry packet based on information received from at least one sensor; generating, by the controller and based on information in the telemetry packet, a first blockchain message wherein data in the first blockchain message is usable for verifying at least one of: authenticity and integrity of the information in the telemetry packet; storing the telemetry packet by a server; generating and signing by the controller a blockchain transaction to send the first blockchain message to a blockchain network; and adding a block to a blockchain database, by a blockchain miner node associated with said network and based on the first blockchain message.

An embodiment may include using a key of the block to retrieve the first blockchain message; and using data in the first blockchain message to verify at least one of: authenticity and integrity of the information in the telemetry packet. The blockchain transaction may include a cryptocurrency transaction between a wallet associated with the controller and a wallet associated with the server. In some embodiment the blockchain miner node is adapted to verify a blockchain transaction between the wallet associated with the controller and the wallet associated with the server.

An embodiment may include generating, by the server, a second blockchain message based on a status of the stored telemetry packet; generating, by the server, a blockchain transaction to send the second blockchain message to a blockchain network; and adding a block to a blockchain database, by the blockchain miner node and based on the second blockchain message. Generating the blockchain message may include encrypting information received from the at least one sensor to produce encrypted data; and including the encrypted data in the blockchain message.

Generating the first blockchain message may include storing in the first blockchain message at least a portion of the telemetry packet. Generating the second blockchain message may be based on information in the telemetry packet and information obtained from at least one additional source. The blockchain transactions may be performed according to one of: bitcoin protocol and Ethereum protocol. The information included in the telemetry packet may include data related to at least one of: a location, a timestamp, an address, a temperature, light exposure, humidity, pressure, proximity and an acceleration.

In some embodiment a server may store blockchain ledger information. In some embodiment a tracking device may include at least one of: a long-range transceiver circuit adapted to communicate over a wide area network and a short-range transceiver adapted to communicate with remote units. In some embodiments, a method of sending sensor information from a device may include reading, by a controller in the device, sensor information from a sensor; generating, by the controller, a blockchain message based on the sensor information; signing, by the controller, the blockchain message; sending, by the controller, the message to a blockchain node within a blockchain network; and adding a block to a blockchain database, by a blockchain miner node associated with said network and based on the blockchain message. The sensor may be at least one of: a temperature sensor, a pressure sensor, a light exposure sensor, a proximity sensor, a humidity sensor and a sensor adapted to read a bar-code or a QR code. The blockchain network may be one of: a Bitcoin network, an Ethereum network, a Ripple network and a Hyperledger network.

In some embodiments, a blockchain message may cause execution of a smart-contract process, the smart-contract process including relating data in a blockchain message to at least one predefined criterion. In some embodiments, a method may include defining a smart contract related to a shipment, the smart contract including at least one constraint; generating and signing a blockchain transaction, by a controller in a device, the blockchain transaction including information related to the shipment; determining, based on the blockchain transaction and based on the smart contract whether or not the at least one constraint was breached; and if the constraint was breached then performing an action defined in the smart contract. The action may involve a financial transaction involving an entity related to the shipment. An embodiment may read information from a sensor and include the information in a blockchain transaction.

A system may include a memory and a controller included in a shipment, the controller may be configured to: read sensor information from a sensor; generate a blockchain message based on the sensor information; sign the blockchain message; and send the blockchain message to a blockchain network through a blockchain node connected to a blockchain network. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of a prior art system;

FIG. 2 shows high level block diagram of a prior art system;

FIG. 3A shows a high-level block diagram of a computing device according to illustrative embodiments of the present invention;

FIG. 3B shows a high-level block diagram of a system according to illustrative embodiments of the present invention;

FIG. 4 shows a high-level block diagram of a system according to illustrative embodiments of the present invention;

FIG. 5. shows flowcharts of methods according to illustrative embodiments of the present invention; and

FIG. 6. shows flows and data structures according to illustrative embodiments of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

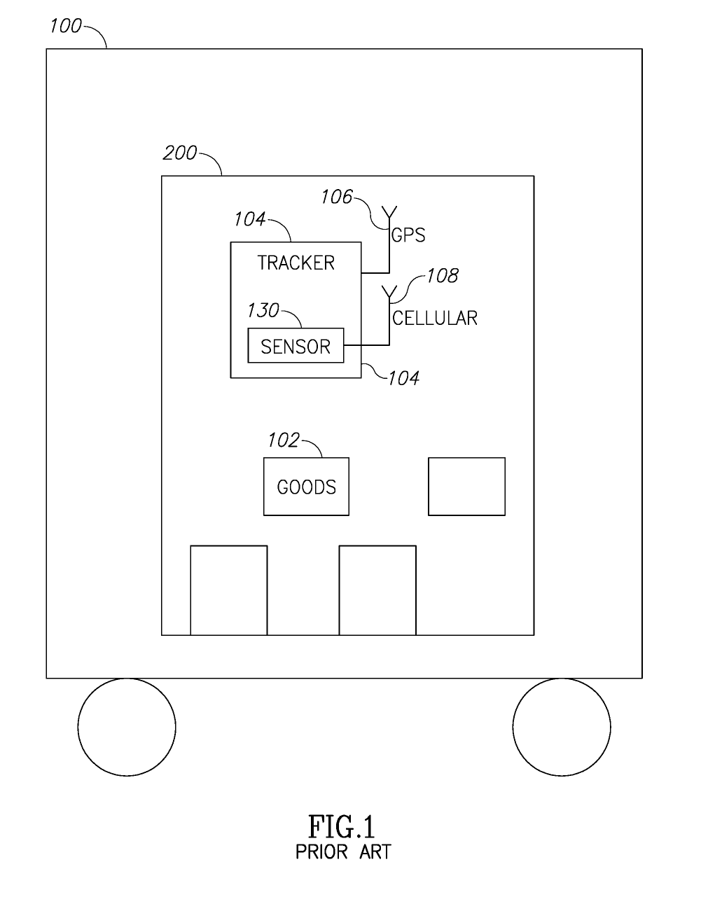

Reference is made to FIG. 1, a prior art system for determining critical parameters in perishable goods shipment. As shown, a prior art system may include a shipping vessel 100 that carries a container 200. As further shown, the container may include goods 102 and a tracker/sensor 104 that may include a sensor 130. The system may include multiple radio interfaces, e.g., a global positioning system (GPS) antenna 106 and a cellular interface antenna 108.

Sensor 130 may be a temperature sensor. In operation, tracker/monitor 104 reads sensor information from sensor 130, obtains location information from the GPS receiver and sends this information via the cellular interface antenna 108. Information can be sent, by tracker/monitor 104, as plain text or encrypted, to a user or a server.

It is noted that once this information is sent, it needs to be stored, e.g., in a storage system or a database. After the shipment has arrived at its destination the shipper may want, or be required to, present a report comprising a set of measurements, which originated from tracker/monitor, for example, data for a report is obtained from a database where information from tracker/monitor 104 is stored.

The system shown in FIG. 1 is highly prone to illicit activities that may jeopardize the validity of the data. For example, if a party wants to present a fraudulent report of the shipment parameters (e.g., to falsely report that shipped goods were kept under acceptable conditions throughout a shipment), the party can change the records in the database, e.g., hire a hacker (or a disgruntled employee) to modify records in a database or server. In the system shown in FIG. 1, records can be deleted, changed or added even if they were originally transmitted in a secure protocol with encryption. Furthermore, the report itself might be falsified with omitted or changed data points due to the fact that the receiving party has no way to verify the authenticity thereof.

Sometimes, in systems such as the one shown in FIG. 1, the monitor has no cellular connection, or it may be a simple logger without a cellular radio. In such cases, the data is checked after the journey is completed. This presents another vulnerability, namely, records on non-volatile memory such as flash memory on the monitoring/logging device itself can be changed by capable hands.

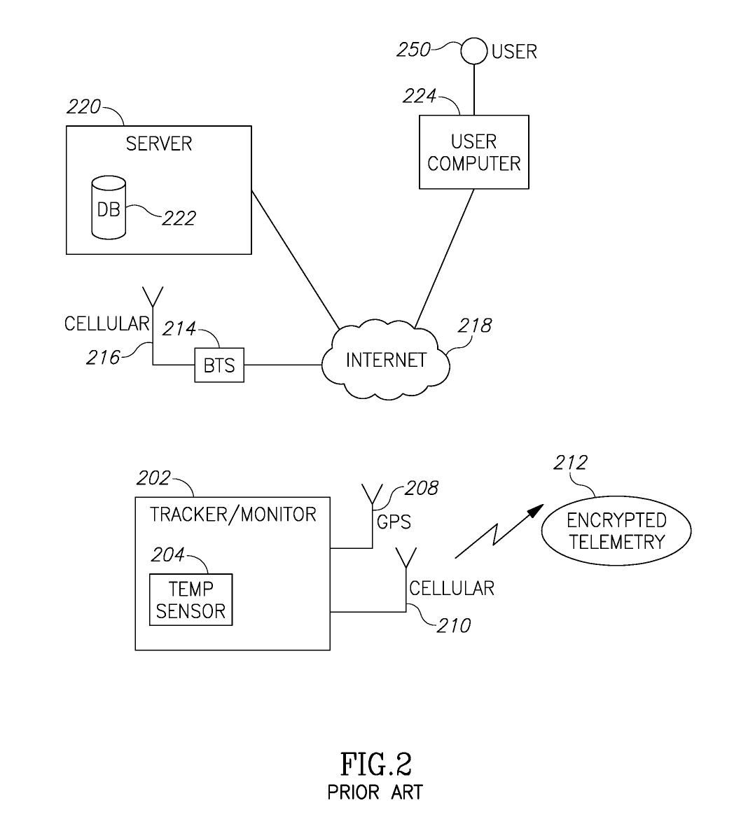

Reference is made to FIG. 2, a prior art system for monitoring temperature, location and other critical parameters during a shipment. As shown, the system shown in FIG. 2 may include a server 220 that includes a database 222, a user computer 224 used by a user 250, a base station 214 with antenna 216 and a network 218 that enables server 220, computer 224 and base station 214 to communicate. As further shown, the prior art system shown in FIG. 2 may include a tracker/monitor 202 that includes a temperature sensing device 204. Tracker/monitor 202 may include, or be connected to, a GPS component (e.g., receiver and antenna) 208 that provides location data or information, and a cellular transceiver and/or antenna 210. For example, cellular transceiver and/or antenna 210 may enable communication over 2G, 3G or Long Term Evolution (LTE) networks.

Typically, tracker 202 is in a container holding valuable perishable goods. Typically, tracker 202 transmits encrypted telemetry packets (e.g., telemetry packets as shown by block 212) containing collected information via a cellular connection through base station 214 and its antenna 216 to network 218 (that may be the internet). This information is typically transmitted to server 220, which stores it in a database 222. The user 250 through computer 224 may access the server database 222 through the internet 218 or conversely obtain a report from server 220.

An advantage of the system shown in FIG. 2 is that the information sent from the tracker/monitor 202 is encrypted and is therefore relatively protected from eaves-dropping and potentially other threats. However, a major disadvantage of the system shown in FIG. 2 is that the transmitted information from tracker/monitor 204 is transmitted between monitor 202 and server 220. The user 250 is not a party to this communication, nor does he/she have any way to verify its content in real time. Another disadvantage of the system shown in FIG. 2 is that database 222 is prone to record deletion, record changing, or record falsification. This can be done by hacking into server 220 or by hiring an insider to perform this forgery.

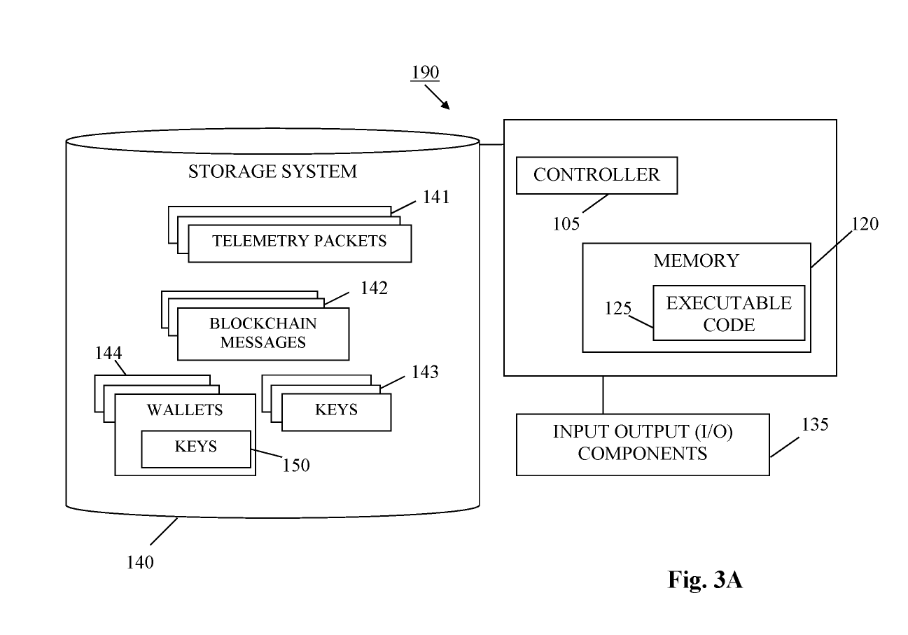

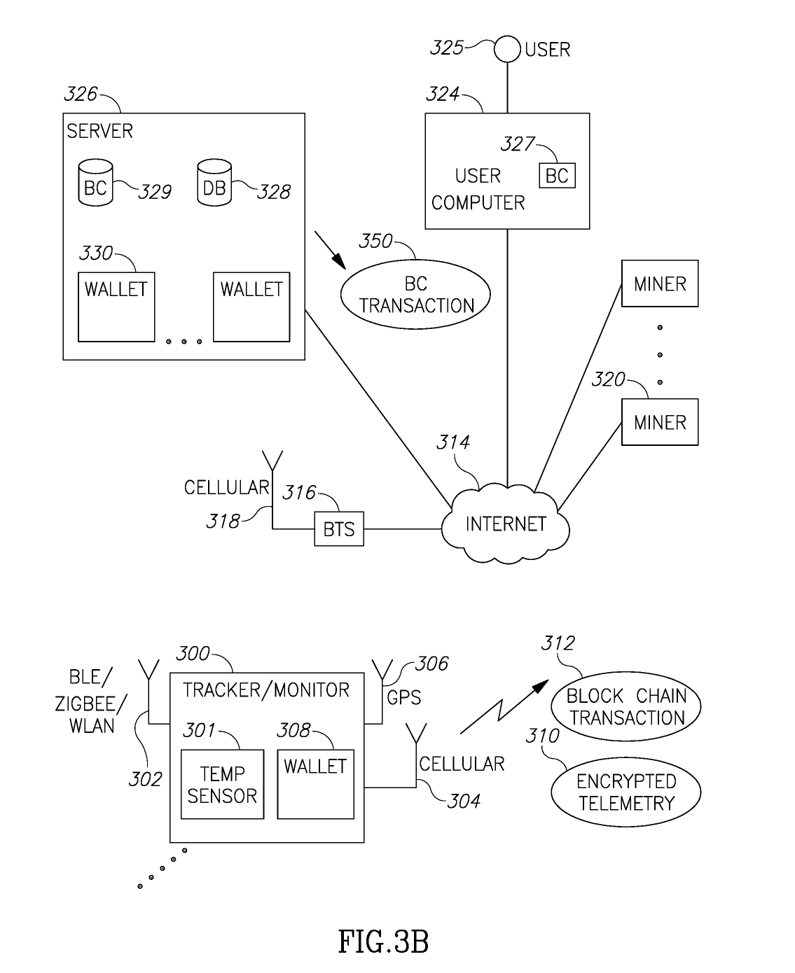

Reference is made to FIG. 3A, showing a non-limiting, high-level block diagram of a computing device or system 190 that may be used to secure and verify information from transportation monitors according to some embodiments of the present invention. Computing device 190 may include a controller 105 that may a hardware controller. For example, computer hardware processor or hardware controller 105 may be, or may include, a central processing unit processor (CPU), a chip or any suitable computing or computational device. Computing system 190 may include a memory 120, executable code 125, a storage system 140 and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 190 may be included in, and one or more computing devices 190 may be, or act as the components of, a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 190) to perform the various functions described herein.

Executable code 125 may be executed by controller 105 possibly under control of an operating system. For example, executable code 125 may be an application that generates a telemetry packet based on information received from at least one sensor, generates, based on information in the telemetry packet, a blockchain message usable for verifying an authenticity and/or integrity of the information in the telemetry packet and associates the blockchain message with the telemetry packet as further described herein. The terms “blockchain”, “block chain” and “block-chain” as used herein may mean, or relate to, the same thing, and may be used interchangeably herein. Although, for the sake of clarity, a single item of executable code 125 is shown in FIG. 3A, a system according to some embodiments of the invention may include a plurality of executable code segments similar to executable code 125 that may be loaded into memory 120 and cause controller 105 to carry out methods described herein. For example, units or modules described herein, e.g., tracker/monitor unit (TMU) 300, base station 316, computer 324 and server 326 (all of which are shown in FIG. 3B and described herein), may be, or may include, controller 105, memory 120 and executable code 125.

Storage system 140 may be or may include, for example, a hard disk drive, a CD-Recordable (CD-R) drive, a Blu-ray disk (BD), a universal serial bus (USB) device or other suitable removable and/or fixed storage unit. As shown, storage system 140 may include telemetry packets 141, blockchain messages 142, keys 143 and cryptocurrency wallets 144 (collectively referred to hereinafter as telemetry packets 141, blockchain messages 142, keys 143 and wallets 144 or individually as telemetry packet 141, blockchain message 142, key 143 and wallet 144 merely for simplicity purposes).

The terms “cryptocurrency wallet” or simply “wallet” as used herein relate to a cryptocurrency wallet as known in the art and may be used interchangeably herein. Generally, a cryptocurrency wallet is a secure digital object (digital wallet) used to store, send, and receive digital currency like Bitcoin. Wallets 144 may include cryptographic keys 150 used to communicate with a network, sign blockchain transactions or authenticate the trackers identity vis-à-vis a server. Keys 150 may be similar to keys 143. Generally, keys 143 and 150 may be any code, token or value used for cryptocoins (crypto coins or crypto-coins), blockchain transactions as known in the art. For example, keys 150 and/or 143 may be public or private keys, e.g., a private key 150 may be used to derive a public key 143 as known in the art.

Telemetry packets 141, blockchain messages 142, keys 143 and wallets 144 as referred to herein may be any suitable digital data structure or construct or computer data objects that enables storing, retrieving and modifying digital values. For example, telemetry packets 141, blockchain messages 142, keys 143 and wallets 144 may be files, tables, lists or other objects in a database in storage system 140, or they may be memory segments in memory 120. Telemetry packets 141, blockchain messages 142, keys 143 and wallets 144 and may each include a number of fields or entries that can be set or cleared, a plurality of parameters for which values can be set, a plurality of entries that may be modified and so on.

Content may be loaded from storage system 140 into memory 120 where it may be processed by controller 105. For example, telemetry packets 141, blockchain messages 142, keys 143 and wallets 144 may be loaded into memory 120 and used for securing and verifying information from transportation monitors as further described herein.

In some embodiments, some of the components shown in FIG. 3A may be omitted. For example, memory 120 may be a non-volatile memory having the storage capacity of storage system 140. Accordingly, although shown as a separate component, storage system 140 may be embedded or included in system 190, e.g., in memory 120. For example, in some embodiments, telemetry packets 141, blockchain messages 142, keys 143 and wallets 144 are stored in a memory 120 of a tracker or monitor unit thus eliminating the need for a storage system 140 in the tracker unit.

I/O components 135 may be, may be used for connecting (e.g., via included ports) or they may include: a mouse; a keyboard; a touch screen or pad or any suitable input device. I/O components may include one or more screens, light emitting diodes (LEDs), touchscreens, displays or monitors, speakers and/or any other suitable output devices. Any applicable I/O components may be connected to computing device 190 as shown by I/O components 135, for example, a wired or wireless network interface card (NIC), a cellular network interface or component, a GPS unit, a GLONASS (GNSS) unit, a universal serial bus (USB) device or an external hard drive may be included in I/O components 135.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

Where applicable, modules or units described herein, may be similar to, or may include components of, device 190 described herein. For example, TMU 300 described herein may be or may include a controller 105, memory 120 and executable code 125.

The present invention is a novel and useful system, method and apparatus for securing shipping critical parameter records against forgery, whilst allowing the various users to verify its authenticity. Although the description herein relates mainly to cold-chain shipment it will be understood that embodiments of the invention can be used for any type of shipment and/or any applicable tracking, monitoring, sensing and reporting conditions or other aspects of shipped goods.

The present invention teaches a novel and useful system, method and apparatus for monitoring, tracking, logging and securing shipment critical parameters (e.g. temperature, location, humidity, light exposure, etc.). The present invention provides means to authenticate the data and prevent post-factum falsification, omission, or forgery of records. According to some embodiments, a system can be constructed using real time monitors or loggers that utilize blockchain technology by creating blockchain transactions, which hold partial information about the records. A block chain ledger created from these transactions is an immutable network consensus providing all parties with the ability to check and verify the authenticity of a set of records and to prevent illicit forgery activities.

Some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

Reference is made to FIG. 3B, showing a non-limiting, high-level block diagram of a system according to illustrative embodiments of the present invention. The system shown in FIG. 3B can be used for determining, storing verifying and authenticating critical parameters related to shipment of perishable or other goods. As described, in some embodiments, verifying and authenticating critical parameters related to shipment of perishable or other goods is performed and/or achieved using block chain technology.

As shown, a system may include a server 326 than may include wallets 330, a database 328 and a block chain ledger 329. For example, server 326 may include or be operatively connected to a storage system 140 and wallets 330, database 328 and block chain ledger 329 may be stored in the connected or included storage system 140. As further shown a system may include a TMU 300 that may include, a cryptocurrency wallet 308, a temperature sensor 301, a GPS unit or component 306, a cellular component and antenna 304 and a short-range transceiver 302. A controller (e.g., controller 105) in TMU 300 may generate and send encrypted telemetry packets 310 and blockchain transactions 312.

As further shown, a system may include a plurality of miner computers or nodes 320 (also referred to herein as blockchain nodes) and a user computer 324 used by a user 325. User computer may include or store (e.g., in an attached storage system 140) a block chain ledger 327 as shown. As shown a system may include a base station 316 that can communicate via cellular antenna 318. As further shown a system may include a network 314. Each of server 326, user computer 324 and TMU 300 may be or may include components of computing device 190, e.g., Each of server 326, user computer 324 and TMU 300 may include a hardware controller 105, a non-transitory memory 120 and one or more executable code segments similar to executable code 125.

Network 314 may be, may comprise or may be part of a private or public IP network, or the internet, or a combination thereof. Additionally, or alternatively, network 314 may be, may comprise, or may be part of, a global system for mobile communications (GSM) network. For example, network 314 may include or comprise an IP network such as the internet, a GSM related network and any equipment for bridging or otherwise connecting such networks as known in the art. In addition, network 314 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 314 are implied but not shown, e.g., access points, base stations, communication satellites, GPS satellites, routers, telephone switches, etc. It will be recognized that embodiments of the invention are not limited by the nature of network 314.

In some embodiments TMU 300 is placed inside a container used for shipping valuable and/or perishable goods. TMU 300 may include any component enabling TMU 300 to communicate wirelessly, e.g., short-range transceiver 302 may enable TMU 300 to communicate over Bluetooth Low Energy (BLE), Zigbee, or Wireless LAN (WLAN/Wifi) or any other suitable networks. It will be noted that any number of TMUs 300 may be included in a container or shipment and a plurality of TMUs 300 may communicate with one another, e.g., using their short-range transceivers 302. Any data or information may be stored by a controller 105 in TMU 300, e.g., in a connected or included storage system 140 or in memory 120. For example, controller 105 in TMU 300 may store, in wallet 308 or elsewhere, a unique identification of the TMU 300, unique identifications of blockchain records and the like.

In some embodiments, after obtaining sensor information from sensor 301 and possibly other sensors, e.g., after receiving location from GPS antenna 306 or any other sensors, TMU 300 encrypts data collected from sensors and/or other data as described to produce an encrypted telemetry packet 310 and sends both the encrypted telemetry packet 310 and a blockchain transaction 312 from wallet 308 to one of the server wallets 330.

In some embodiments, blockchain transaction 312 (from TMU 300 to server 326) includes a transaction of a virtual coin (e.g., Bitcoin) from wallet 308 to one of wallets 330 and the blockchain transaction 312 further includes concise, descriptive information that uniquely and/or unambiguously identifies, characterizes or describes a specific telemetry packet 310. In some embodiments, TMU 300 associates a (possibly encrypted) telemetry packet 310 with a blockchain transaction 312. For example, a list or table that includes references or other data may be used to associate a telemetry packet 310 with a blockchain transaction 312. An association of a telemetry packet 310 with a blockchain transaction 312 may include, or be realized by, including, in the blockchain transaction 312, concise, descriptive information that uniquely and/or unambiguously identifies, characterizes or describes the associated telemetry packet 310.

Concise, descriptive information that uniquely and/or unambiguously identifies, characterizes or describes a telemetry packet 310 may include a time stamp, a hash field, and any part or portion of data or information in the telemetry packet 310, for example, descriptive information in a blockchain transaction 312 may include sensor information (e.g., a temperature) and/or the GPS location. A hash field or value included in a blockchain transaction 312 may be computed, based on data in a telemetry packet 310, by a one-way function algorithm such as the Secure Hash Algorithm (SHA, e.g., standards FIPS PUB 180, 180-1, 180-2, 202) such that it is practically impossible to change the content in the telemetry packet 310 and keep the hash value valid. A hash value computed or calculated as described and included in blockchain transaction 312 uniquely identifies specific content in a telemetry packet 310, accordingly, to determine whether or not content of a telemetry packet 310 was modified after a first (original) hash value for a telemetry packet 310 was computed, an embodiment may re-compute the hash value (to produce a second or subsequent hash value) for the telemetry packet 310 and if the re-computed second hash value is not the same as the first (original) hash value then the embodiment may determine that the telemetry packet 310 was modified after the first (original) hash value was computed. Accordingly, an embodiment may guarantee integrity and/or validity of content or data in telemetry packets 310. By including the hash value and other descriptive or characterizing data for a telemetry packet 310 in a separate blockchain transaction 312, embodiments of the invention provide a novel, unprecedented way of guaranteeing and/or verifying the validity and/or integrity of data in telemetry packets. It will be noted that verifying content of a telemetry packet 310 based on data in an associated blockchain transaction 312 can be done at any point in time. For example, days, months or even years after data or content of a telemetry packet 310 is stored in database 328 in server 326, and data in an associated blockchain transaction 312 is stored in one of wallets 330, the validity or integrity of data in the telemetry packet 310 can be verified based on data in the associated blockchain transaction 312 as described.

In some embodiments, both the block chain transaction 312 and the encrypted telemetry 310 are sent through cellular base station 316 and its cellular antenna 318 to network 314 and from there the telemetry packet 310 is communicated to server 326 that stores it in database 328. In some embodiments, blockchain transactions 312 are verified by miner computers 320 and stored in a blockchain ledger. Generally, and as known in the art, miner nodes or computers 320 perform the process of adding transaction records to a public ledger and are further adapted to verify blockchain transactions between wallets. As known in the art, a public ledger is generally a chain of blocks that serve to confirm transactions, thus enabling to distinguish legitimate transactions from illegitimate ones (e.g., Merkle Trees).

In some embodiments blockchain transaction 312 may activate a smart contract, which has been previously published and stored on the blockchain ledgers. This contract may, in turn, check the validity of the data, based on some previously defined set of criteria and perform an action based on said criteria. The action may comprise a financial transaction, a notification message or operation of yet another smart-contract.

In some embodiments, server 326 computes a secondary or additional concise, descriptive information that uniquely and/or unambiguously identifies, characterizes or describes a telemetry packet 310 received from TMU 300 as described. For example, a secondary or additional descriptive information computed or produced by server 326 may include an address or other identifying data of server 326 or of TMU 300, statistical analysis of received data, time information and the like. Secondary or additional descriptive information computed or produced by server 326 may be, or may include, any information or data that may appear in a post-shipment report or information collected from one or more external databases (e.g., geolocation, weather, exchange rates, etc.).

In some embodiments, server 326 creates a blockchain transaction 350 that includes some, or even all, of the secondary or additional information and/or a hash key. Accordingly, an additional security and verification layer is added to information generated by TMU 300 such that integrity and validity of data or information stored by a system (e.g., in database 328) is maintained and can be readily verified or determined. In some embodiments, blockchain transactions 350 are verified by miner computers 320 and are stored in a blockchain ledger as described. In some embodiments, a blockchain transaction 350 includes sending the virtual coin previously sent from TMU 300 to server 326 back to TMU 300. For example, a blockchain transaction 350 includes sending the virtual coin sent from wallet 308 to one of wallets 330 from one of wallets 330 back to wallet 308 in TMU 300.

By linking the original TMU 300 generated information with a blockchain transaction as described, an embodiment creates an immutable record with proof of work. Once a blockchain transaction is verified as described, it is practically impossible to undetectably delete or alter telemetry packets 310 (e.g., remove telemetry packets 310 from database 328) or undetectably modify data in telemetry packets 310.

Furthermore, and as described, the secondary or additional information generated by server 326 may be stored, e.g., in database 328 and by linking this information into yet another blockchain transaction as described, an immutable record ledger entry of this information is created, thus, after a transaction of the secondary or additional information is verified, it is practically impossible to change, delete or add information stored in the database in a non-detectable way.

In some embodiments, secondary blockchain transaction 350 may operate a smart contract previously published on the blockchain network. This contract may, in turn, check the validity of the data, based on some previously defined set of criteria and perform an action based on said criteria. The action may comprise a financial transaction, a notification message or operation of yet another smart-contract.

In some embodiments, user 325 uses computer 324 to access server 326 and/or database 328, e.g., to view block chain ledger 329. In some embodiments and as shown, a copy of the blockchain ledger 327 is maintained in computer 324. Accordingly, user 325 can verify the authenticity of any record on database 328, whether originating from TMU 300 or from secondary information computed in the server 326, by accessing either blockchain ledger 327 or blockchain ledger 329 and comparing the information therein with the one obtained from database 328. For example, when a report related to a shipment is issued, user 325 may be able to compare entries in the report with entries in blockchain ledger 327 making sure no foul play is afoot. Server 326 may use block chain ledger 329 to include, in a report it generates, verification messages, e.g., next to each report line, thus enabling a user to quickly and easily identify suspicious events.

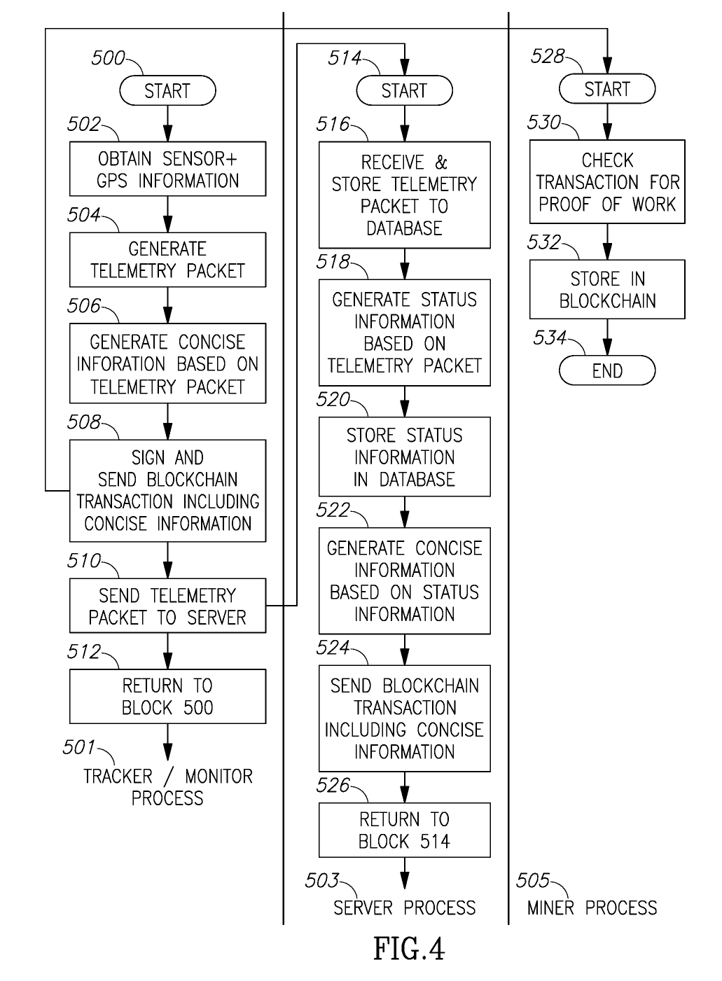

Reference is made to FIG. 4, a high-level block diagram of a system (or hub) 400 according to illustrative embodiments of the present invention. For example, TMU 300 may be, or may include components of system 400, accordingly, it will be understood that any components included in system (or hub) 400 as described herein may be included in TMU 300 and any components included in TMU 300 as described herein may be included in system (or hub) 400.

In some embodiments, system 400 may act or function as a hub that servers a plurality of sensors and/or a plurality of TMUs 300. For example, a shipment may include one or more containers with a plurality of sensors or a plurality of TMUs 300 and the plurality of sensors or TMUs 300 may communicate with system or hub 400. For example, system 400 may receive sensor data from a plurality of sensors or TMUs 300 and generate blockchain transactions 312 and/or encrypted telemetry packets 310 based on the received sensor data. Accordingly, embodiments of the invention enable securing, verifying and/or guaranteeing authenticity and integrity of data from any number of sensors or TMUs 300.

As shown, system 400 may include a CPU 440, which may be programmed to process, store, transmit and receive data. CPU 440 may be connected to a crystal 428 used for clock generation, RAM 424 may be used to hold data and code, GPS location system 414 may be connected to antenna 416, crystal 428 may be used for clock generation for a cellular radio 410 connected to antenna 412, which may be used to transmit data from local sensors 426, e.g., data obtained by sensors 426 related to ambient or other temperature, light exposure, pressure, humidity, acceleration, proximity, location from the GPS radio 414, as well as data received from remote units and/or commands received from a remote server (e.g., from server 326).

CPU 440 may also be connected to a Flash NV memory 422 unit used to store information from sensors 426 and information in wallet 401, which may include a set of keys 403 that may be similar to keys 143 and/or 150. CPU 440 may connect to the cloud or to a server over the internet, e.g., using a short-range radio system 418 such as BLE, Zigbee or Wifi connected to antenna 420 and CPU 440 may be connected to a set of sensors 426 used to measure critical parameters within the container that includes system 400. CPU 440 may also be connected to a USB port 450 that may be used for downloading data into hub 400 or for uploading data from hub 400.

USB port 450 may be used to download data from Flash memory 422 as a redundancy for the cellular air interface once the shipment arrives at its location. In some embodiments system 400 also contains a rechargeable battery 402 such as in a Lithium Ion (Li-Ion) or Lithium Ion Polymer (LiPo), a power management system 406 used to control the voltages and currents throughout system 400 and a charger 408 connected to battery 402 and power DC port 404, used to charge the battery from an external power source.

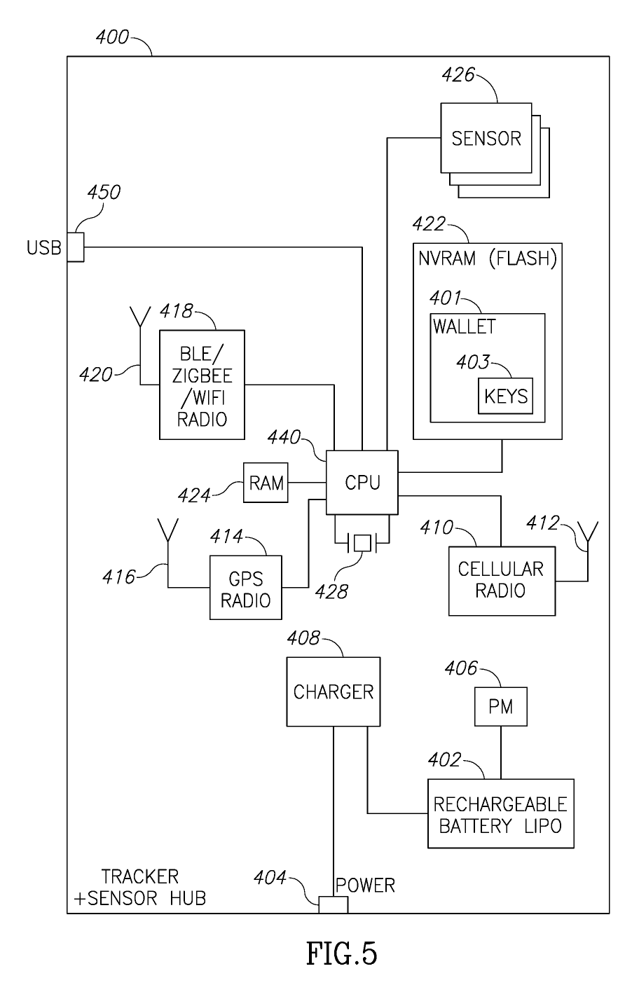

Reference is made to FIG. 5 which shows flowcharts of methods according to illustrative embodiments of the present invention. The flows and methods shown in FIG. 5 and described herein may be used for monitoring, storing and authenticating critical parameter information in shipments of perishable goods. FIG. 5 shows three flows or processes, these are process or flow 501 which may be carried out by a monitor or tracker, e.g., TMU 300, process or flow 503 which may be carried by a server, e.g., server 326 and process or flow 505 which may be carried out by a miner or blockchain node, e.g., one of miner computers or nodes 320.

Process or flow 501 may start as shown by block 500, for example, controller 105 in TMU 300 may continuously, repeatedly or periodically commence process 501. As shown by block 502, flow 501 may include obtaining data and measurements from sensors and units, e.g., obtaining input from temperature sensor 301, GPS unit 306 and/or any other sensor or unit in, or connected to, TMU 300.

As shown by block 504, flow 501 may include generating a telemetry packet. For example, controller 105 may format or convert data obtained as shown by block 502 into a telemetry packet and controller 105 may further encrypt the telemetry packet, e.g., to produce an encrypted telemetry packet 310.

As shown by block 506, flow or process 501 may include generating concise information based on the telemetry packet. For example, the concise information may include snippets of sensor or GPS data obtained as shown by block 502, time stamp information, length or size of data in the telemetry packet, a hash value computed based on data in the telemetry packet. In some embodiments, the concise information may include the entire telemetry packet. As described, the hash value computed for the telemetry packet may be unique for the data in the telemetry packet, that is, if after computing a hash value for an original telemetry packet the original telemetry packet is modified to produce a modified telemetry packet then a hash value computed for the modified telemetry packet will be different from the hash value computed for the original telemetry packet. Accordingly, a hash value may be used to verify integrity and/or validity of a telemetry packet and/or data in a telemetry packet. By further securing the hash value using blockchain techniques as described, embodiments of the invention guarantee integrity and validity of telemetry information and further fully protect telemetry data from unauthorized modifications or falsifications.

As shown by block 508, process or flow 501 may include signing a transaction, according the blockchain protocol, and sending a blockchain transaction that includes the concise information generated as shown by block 506. It is understood that once the transaction has been signed in the device in step 508 and while the device may be the only entity storing the keys enabling the signing of the transaction, no further untraceable or undetectable modification, falsification, replaying, lengthening or shortening of the message is possible.

Signing a transaction as referred to herein may be, or may include, any operation or process that produces authentication for content in a transaction, thus securing data in the transaction and/or protecting the data from being undetectably modified. Signing a transaction as referred to herein may be, or may include, any method or technique that provides integrity, non-repudiation, and authentication to content in the transaction. Signing as referred to herein may involve any mathematical operation or algorithm, e.g., creating a hash (that may be a signature) using information from both the data in a transaction and information in a key held by TMU 300. Accordingly, signing a transaction as referred to herein may produce an immutable copy or instance of data in a transaction and enable an embodiment to detect if or when data in a transaction has been tampered with. For example, TMU 300 may sign a transaction 312 according to the Ethereum protocol by: producing a Secure Hash Algorithm 3 (SHA-3 or HASH3) signature of the content in the transaction 312 and using the signature and an Elliptic Curve Digital Signature Algorithm (ECDSA) to sign the transaction.

In some embodiments the blockchain transaction generated and signed at step 508 may activate a smart contract, which has been previously published and stored on the blockchain ledgers. The smart contract (or a process based on the smart contract, also referred to herein as a smart contract process) may, in turn, check the validity of the data, based on a previously defined set of criteria and the process may perform an action based on the criteria. The action may comprise a financial transaction, a notification message or an operation, execution or invocation of yet another smart contract. For example, the smart contract process may check the temperature detected as reported in the blockchain transaction and compare it with a set of thresholds to determine whether or not temperature in a container used for shipping goods has exceeded a threshold temperature (a condition that may harm the shipped goods). If the detected temperature (as reported in the blockchain transaction) is out of bounds (as defined in the smart contract), the smart contract process may generate a penalty transaction to the shipper, etc. It will be understood that although a smart contract process is typically executed by a miner node (e.g., one of miner nodes 320), a smart contract process as described herein may be executed by any suitable server or node, e.g., if server 326 is connected to a blockchain network then server 326 may execute a smart contract process.

In some embodiments, a blockchain transaction generated and signed, e.g., as described with reference to step 508, may contain a location (e.g., in the form of coordinates as known in the art), for example, location information may be determined using a GPS component or an indoor location system or technique (e.g., WiFi based indoor location as described herein). Based on a location reported by TMU 300 a smart contract may check the distance of a shipment from its destination and, for example, if the shipment is sufficiently close to its destination (e.g., less than 100 meters), the smart contract (e.g., method2 described herein) may generate a financial transaction to the shipper wallet, thus automatically paying a shipper or sender for a shipment that has been successfully delivered.

Although temperature and location are mainly described herein it will be understood that any conditions or aspects that may be sensed, measured or determined by an embodiment as described herein may be used by a smart contract as described. For example, a transaction taxing a shipper may be generated as described based on a shipment being exposed to bright light that exceeds a level defined in a smart contract, e.g., TMU 300 may report light exposure level in a blockchain transaction, method1 may compare the reported level to a threshold and if the level reported by TMU 300 is higher than a threshold then method2 may fine or tax the shipper or other entity as described. Similarly, automatic taxing or payment may be enforced due to a humidity level that is higher than a threshold, pressure, acceleration or angular speed that exceed a threshold, predefined rate or level and so on.

For example, controller 105 generates and sends blockchain transaction 312 as described herein. A blockchain transaction generated, sent and stored as described may include any data and/or metadata. For example, data in a blockchain transaction or message may include sensor data, e.g., temperature, location, humidity and so on and data in a blockchain transaction or message may further include metadata, e.g., the time the message was generated and/or sent, the length or size of the message, information related to a sender (e.g., a media access control (MAC) address of TMU 300) and so on.

As shown by block 510, the telemetry packet may be sent to a server, e.g., TMU 300 may send a telemetry packet to server 326 as described herein. As described, to prevent eavesdropping, the telemetry packet may be encrypted before being sent. As shown by block 512, flow or process 501 may be repeated, e.g., controller 105 may repeatedly, periodically or continuously perform steps of flow 501 such that data related to a shipment is continuously provided to a user thus enabling to user to closely track a shipment.

As shown by the arrow connecting blocks 510 and 514, process or flow 503 may start, or be triggered, by a reception of a telemetry packet sent as shown by block 510. As shown by block 516, flow or process 503 may include receiving and storing a telemetry packet, e.g., server 326 receives an encrypted telemetry packet 310 from TMU 300, decrypts the received encrypted telemetry packet and stores a decrypted telemetry packet in database 328.

As shown by block 518, flow or process 503 may include generating status information based on the telemetry packet received as shown by block 516. For example, based on the received telemetry packet and based on other aspects, server 326 generates status information for, or related to, the received telemetry packet. For example, status information generated or collected by server 326 may include information obtained from remote databases, the internet and the like. Status information generated or collected by server 326 may include metadata such as time of reception of a telemetry packet, statistical data, alerts and/or any information that may be included in a report that may be generated at a later stage. The status information may contain a physical address based on partial location information (e.g., WiFi base stations), weather forecast information, proximity to other TMUs, proximity to customer premises, etc.

As shown by block 520, the status information may be stored in a database. For example, server 326 generates and/or collects the status information and stores it in database 328.

As shown by block 522, flow 503 may include generating concise information based on the status information. For example, concise information based on the status information may include snippets or portions of the status information or it may include all of the status information, concise information based on the status information may include time stamp information, length information and/or a hash value that may be calculated based on, or for, the status information, e.g., as described herein with respect computing a hash value for a telemetry packet.

As shown by block 524, flow or process 503 may include generating, signing and sending a blockchain transaction that includes the concise information generated as shown by block 522. The blockchain transaction generated and sent as shown by bock 524 may include the concise information generated as shown by block 522 and may further include a virtual coin. For example, in block 508, TMU 300 sends a virtual coin to server 326 and in block 524, server 326 sends the virtual coin back to TMU 300. As shown by block 526, flow 503 may be repeated, e.g., after completing operations as shown in block 524 server 326 may return to block 514 and receive another telemetry packet from TMU 300.

As shown by the arrow connecting blocks 508 and 528 and the arrow connecting blocks 524 and 528, process or flow 505 may start, or be triggered, by a reception of a blockchain transaction sent as shown by blocks 508 and 528. As shown by block 530, flow or process 505 may include checking the transaction for proof of work. For example, a miner computer 320 runs a blockchain mining processes that verifies the blockchain transactions created in as shown by blocks 508 and 524. Checking a blockchain transaction for proof of work may be done using the blockchain protocol as known in the art. As shown by block 532, flow 505 may include storing a block in a blockchain. Accordingly, information generated as shown by blocks 508 and 524 is included in blocks that are stored in a blockchain thus utilizing the strength of the blockchain technology to secure the information and to further provide optimal measures for validating and/or verifying the authenticity and integrity of the information. As known in the art, the blockchain algorithms ensure that the blockchain transaction ledger is obtained by network consensus and is identical on all computers having a copy of the ledger.

Some embodiments (e.g., controller 105 in TMU 300) may track a container or shipment indoors. For example, controller 105 may determine a location of a shipment, within a building, by sending raw geolocation information to a network geolocation service such as Skyhook and based on information received from the network geolocation service. For example, using technology and services such as provided, for example, by Skyhook, a location of a shipment inside a building may be determined, e.g., using any of GPS data, data provided by cell towers, identifiers (e.g., service set identifiers (SSIDs) or WLAN ID), names and/or IP addresses of access points and the like as known in the art. For example, based on a service and/or data provided by Skyhook, controller 105 may determine its exact location within a building as known in the art. In some embodiments, by identifying WiFi access points and provided with their locations, controller 105 may determine an altitude. For example, controller 105 may determine in which floor of a building a shipment is currently located based on a distance from a known and/or identified WiFi access point or hot spot. In some embodiments, controller 105 may send raw data (e.g., an SSID of a Wifi network or geolocation data, e.g., coordinates) to a server and the server may determine a location of the shipment based on the raw data. In some embodiments, controller 105 may be adapted to determine a location or elevation of a shipment, within a building, by sending raw geolocation information to a network geolocation service, e.g., a service provided by providers such as Skyhook or Google.

Accordingly, blockchain transaction 312 and/or encrypted telemetry 310 may include indoors location information or data. Server 326 may receive the indoors location data and may store the indoors location data in database 328 as described. Block chain transactions 312 that include indoors location data may be verified, e.g., by miner computers 320 and may further be stored within a block chain ledger as described. Accordingly, an embodiment may provide secured and verified indoors location information received from a monitor or tracker of transportation or shipment of goods.

Embodiments of the invention enable verifying authenticity and integrity of data collected, obtained, computed and/or sent by a tracker or monitor unit. For example, embodiments of the invention enable verifying authenticity and integrity of data collected, obtained, computed and/or sent by TMU 300. For example, embodiments of the invention enable verifying authenticity and integrity of data sent in telemetry packets as described.

In some embodiments, a controller in a tracking device generates a telemetry packet based on information received from at least one sensor, the controller further generates, based on information in the telemetry packet, a first blockchain message, wherein data in the first blockchain message is usable for verifying at least one of: authenticity and integrity of the information in the telemetry packet. The controller further associates the telemetry packet with the first blockchain message and sends the telemetry packet to a server and the server stores the telemetry packet, e.g., in a database. The controller further generates a blockchain transaction, signs it and sends it to the blockchain network via a node (e.g., via one of miner nodes 320). For example, the controller in a tracking device may be controller 105 in TMU 300 as described, the server may be server 326 and the blockchain node may be one of miner nodes 320.

In some embodiments, generating the first blockchain message includes storing in the first blockchain message at least a portion of the telemetry packet. For example, TMU 300 may store, in the first blockchain message, temperature values, location data (e.g., coordinates) and/or any other information received from sensors. In some embodiments, all the information included in a telemetry packet is also included in the first blockchain message.

In some embodiments, a key of the block is used to retrieve the first blockchain message and data in the first blockchain message is used to verify at least one of: authenticity and integrity of the information in the telemetry packet. For example, the key is returned when the blockchain node adds the block to the blockchain database, thus, using the key, the block can be retrieved and the data in the block can be compared to data in the telemetry packet thus authenticity and integrity of the information in the telemetry packet can be verified.

In some embodiments, the blockchain transaction includes a cryptocurrency transaction between a wallet associated with the controller and a wallet associated with the server. For example, the blockchain transaction includes a bitcoin that is transferred from wallet 308 to one of wallets 330 as described.

In some embodiments, the blockchain node is adapted to verify a blockchain transaction between the wallet associated with the controller and the wallet associated with the server. For example, one of miners 320 verifies (e.g., using the Bitcoin protocol) a transaction between wallet 308 and one of wallets 330.

In some embodiments, after receiving and storing a telemetry packet, a server generates a second or additional blockchain message based on a status of the stored telemetry packet, generates a blockchain transaction used to send the second blockchain message to a blockchain node, and the blockchain node adds a block to a blockchain database based on the second blockchain message. For example, server 326 generates a second or additional blockchain message based on a status of a telemetry packet received from TMU 300 as described, sends the second or additional blockchain message to one of miner nodes 320 which adds a block to a blockchain database based on the second or additional blockchain message.

In some embodiments, the second or additional blockchain message includes, or is based on, information in the telemetry packet and information obtained from at least one additional source. For example, information obtained from at least one additional source may be, or may include weather conditions or weather forecast from a database on the internet, location of additional trackers or physical address (geolocation).

In some embodiments, generating the blockchain message includes: encrypting information received from the at least one sensor to produce encrypted data, including the encrypted data in the blockchain message and signing it before sending it. For example, TMU 300 uses Advanced Encryption Standard (AES) to encrypt information received from sensor 301 to produce encrypted data and includes the encrypted data in an encrypted telemetry packet 310 as described. In some embodiments, a blockchain transactions as described is performed according to one of: bitcoin protocol and Ethereum protocol.

In some embodiments the blockchain transaction generated in TMU 300 may activate a smart contract once sent to the network, which has been previously published and stored on the blockchain ledgers, which are identical in all nodes and miners. A smart contract may be used, (e.g., by server 326), to check the validity of the data, based on some previously defined set of criteria and perform an action based on said criteria. The action may comprise a financial transaction, a notification message or operation of yet another smart-contract. For example, the smart contract may check the temperature detected and compare it with a set of thresholds to determine whether the goods might be spoiled. If the detected temperature is out of bounds, the contract might cause a penalty transaction to the shipper, etc.

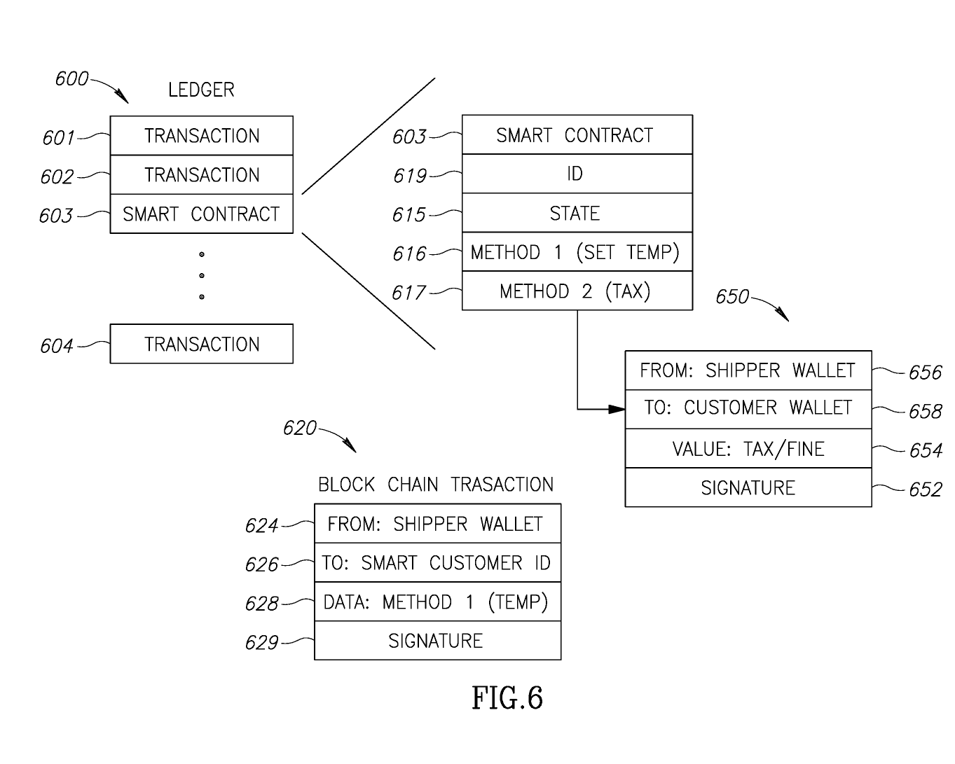

Reference is made to FIG. 6 which shows flows and data structures according to illustrative embodiments of the present invention. FIG. 6 shows the flow of transactions from a tracker (e.g., from TMU 300) to a smart contract 610. FIG. 6 further shows a blockchain ledger schematic diagram 600. Transactions 601, 602 and 604 are standard monetary transactions (e.g., as known in the art), transaction 603 is, or includes, definition and code of a smart contract that may also be included in ledger 600 as shown. As shown, smart contract 603 may include an identification (ID) 619.

As shown, smart contract 603 may include a set of state variables 615, a first method shown as method1 616 that may be used by the tracker 300 to report the temperature and a second method shown as method2 617 (also referred to herein as tax) that may be used to send virtual coins from the shipper to the customer, e.g., in case of a constraint breach such as, for example, when or if an embodiment determines the temperature of a shipment is below a first threshold or above a second threshold or limit then method2 617 may be used to tax an entity responsible for the shipment.

In some embodiments, method1 616 and method2 617 are virtual machine code executed on miner machines to establish network consensus and perform operations.

In some embodiments, a tracker or monitor unit or device (e.g., TMU 300) periodically generates, signs and sends blockchain transactions as shown by block 620. As shown, a transaction 620 may include a “From” field 624 that identifies the source or sender of the transaction, e.g., “From” field 624 may include the sender's wallet number (e.g., the number of wallet 308). As shown, a transaction 620 may include a “To” field 626 that may include an ID of a smart contract, for example, the “To” field 626 may include ID 619 thus pointing to smart contract 603. As shown, a transaction 620 may include a signature 629, e.g., signature 629 is generated by TMU 300 before sending blockchain transaction 620.

As shown, a transaction 620 may include a “Data” field 628 that may include a reference or pointer to a method, for example, the “Data” field 628 in blockchain transaction 620 may point to method 616. A “Data” field 628 may further include a parameter or argument for the referenced method. For example, “Data” field 628 may reference, or point to, method1 616 and may further include a measured temperature value (e.g., 24° C.). As described, provided with an input temperature (as a parameter or argument), method1 616 may check (or compare) the input temperature to a pair of predefined high/low temperatures (e.g., as defined or included in state variables 615) to determine whether or not the input temperature is within a permitted or allowable range. For example, method1 616 may include a definition of a low temperature threshold (e.g., 16° C.) and a definition of a high temperature threshold (e.g., 35° C.), for example, these criteria, thresholds, limits, definitions or values may be included in state variables 615 or hard coded in method1 616, thus, provided with an input temperature (e.g., in blockchain transaction 620) of 22° C., method1 616 may determine that no breach of a constraint has occurred, however, if a temperature of 41° C. is measured by TMU 300, and reported, by TMU 300, in the “Data” field 628 of a signed blockchain transaction 620 (e.g., if, due to a failure of a cooling system, the temperature in a container keeps rising) then method1 616 may determine that a breach of a constraint has occurred.

A first method, process or operation in a smart contract may point, reference, execute or invoke a second method, process or operation in the smart contract. For example, method1 616 may be configured to execute or invoke method2 617 if a breach of a constraint has been identified or determined. For example, in operation, based on data in blockchain transaction 620, method1 616 in smart contract 603 checks if the ambient or other temperature of shipped goods, as reported by TMU 300 in blockchain transaction 620, is within the defined or allowed limits (e.g., as defined in state variable 615). If the temperature indicated in blockchain transaction 620 is out of bounds (e.g., above 35° C. in the above example), then method1 616 may execute or invoke method2 617.

In some embodiment, a second method, process or operation in a smart contract invoked by a first method, process or operation in a smart contract may generate, sign and send a blockchain transaction. For example, after being invoked by method1 616, method2 may generate, sign and send a blockchain transaction according to a set of parameters or values as shown by block 650. As shown by block 650, a blockchain transaction generated, signed and sent by method2 617 may be from the wallet of the shipper of the goods (“From” field 656) or from virtual currency transferred to the contract as an “escrow” from the shipper wallet, to the customer wallet (654) and the blockchain transaction may include a value 654 that may include a tax or fine, e.g., “Value” field 654 may be, or may include, an amount of cryptocoins to be paid, or transferred from the wallet indicated in the “From” field 656 to the wallet indicated in the “To” field 658. For example, the amount (fine or tax) to be paid in case constraints are breached may be included in the state field 615 of smart contract definition 603.

As further shown by block 650, the blockchain transaction generated, signed and sent by method2 617 may include a signature 652 that may be automatically generated by method2 617.

In some embodiments, information included in a telemetry packet (e.g., one sent from TMU 300 to server 326 as described) includes environmental data, time and/or date data or any other information, for example, information included in a telemetry packet may be related to at least one of: a location, a timestamp, an address, a temperature, light exposure, humidity, pressure, proximity, acceleration and angular speed. In some embodiments, server 326 stores (or includes) blockchain ledger information.

As described, in some embodiments, a tracking device (e.g., TMU 300) includes at least one of: a long-range transceiver circuit adapted to communicate over a wide area network and a short-range transceiver adapted to communicate with remote units. For example, TMU 300 includes cellular component or system 304 (long-range) and short-range component or system 302 as described.

According to some embodiments, a system for verifying authenticity and/or integrity of critical parameter information related to a shipment includes a monitor, tracker or hub device (e.g., TMU 300 and/or hub 400) having at least one sensor (e.g., sensors 426 or temperature sensor 301), a processing unit (e.g., controller 105) and a non-volatile memory (e.g., storage system 140, database 328 or memory 120) containing block chain wallet information (e.g., wallet 308). A system may further include a server operatively connected to a database that stores blockchain wallet information (e.g., server 326 as described). A system may further include at least one miner computer connected to a network and adapted to verify blockchain transactions between a wallet of the tracker device wallet and a wallet of the server.

In some embodiments, sensors included in, or connected to tracker or hub device are at least one of: a temperature sensor and a location sensing unit. In some embodiments, blockchain transactions are performed using, or according to, the BitCoin protocol. In some embodiments, blockchain transactions are performed using, or according to, the Ethereum or the Ripple protocols known in the art. In some embodiments, the server stores block chain ledger information. In some embodiments, the tracker or hub device comprises at least one of: a cellular radio and a GPS receiver.

In some embodiments, a method of sending sensor information from a device may include: reading, by a controller in a device, sensor information from a sensor; generating, by the controller, a blockchain message based on the sensor information; signing, by the controller, the blockchain message; sending, by the controller, the message to a blockchain node within a blockchain network; and adding a block to a blockchain database, by a blockchain miner node associated with said network and based on the blockchain message. For example, TMU 300 may read sensor information from temperature sensor 301, generate and sign a blockchain transaction 312 as described, and send blockchain transaction 312 to one of miner nodes 320. One of miner nodes 320 may add a block to a blockchain database based on blockchain message 312.

In some embodiments, the sensor from which information is read may be one of: a temperature sensor, a pressure sensor, a light exposure sensor, a proximity sensor, a humidity sensor and a sensor adapted to read information from a bar-code (or barcode) or any other machine-readable code that may be in the form of printed numbers or patterns printed on a product. In some embodiments, the sensor adapted to read information printed on a product may be adapted to read Quick Response (QR) Code or other two-dimensional code or barcode. TMU 300 may read, receive or obtain information related to a shipment from any applicable system, device or component, for example, TMU 300 may read, receive or obtain information from a GPS system or component, determine its location and thus the location of the shipment in which it is included, and include location information in a blockchain transaction as described. TMU 300 may determine location information based on any suitable systems or data, for example, TMU 300 may determine its indoor location using services such as Skyhook as described herein.

As described, a blockchain network to which miner nodes 320 are connected may be at least one of: a Bitcoin network, an Ethereum network, a Ripple network and a Hyperledger network. Any other network adapted to support a blockchain protocol may be used.

In some embodiments, a blockchain message may cause execution of a process, e.g., a smart-contract process. For example, method1 and method2 are process, the execution of which is cause by a blockchain message sent by TMU 300 as described. In some embodiments, a smart-contract process may include comparing data in a blockchain message to at least one predefined criterion. For example, method1 may be a process that includes comparing a temperature value received in a blockchain message to a predefined temperature as described.

In some embodiments, a method may include defining a smart contract related to a shipment (e.g., by an administrator, by a sender, or by a receiver of a shipment), the smart contract including at least one constraint (e.g., a temperature threshold); generating and signing a blockchain transaction (e.g., by TMU 300 as described), the blockchain transaction including information related to the shipment, for example, a blockchain message 312 may include a temperature value as measured by sensor 301. The method may further include determining, based on the blockchain transaction and based on the smart contract whether or not the at least one constraint was breached (e.g., whether or not temperature in a container has exceeded a predefined threshold as described), and, if the constraint was breached then the method may include performing an action defined in the smart contract. For example, an action may include generating a financial transaction involving an entity related to the shipment (e.g., a tax or fine transaction involving a shipper or sender as described herein with reference to method2).

A system according to some embodiments may include a memory (e.g., memory 120) and a controller (e.g., controller 105) included in a shipment. For example, TMU 300 may be included in a shipment, e.g., inserted into a container used for shipping goods, inserted into a box containing shipped goods and the like. The controller may be configured to: read sensor information from a sensor, e.g., controller 105 in TMU 300 may read information from sensor 301; generate a blockchain message based on the sensor information, e.g., TMU 300 may generate blockchain transaction 312 and include a temperature read from sensor 301 in blockchain transaction 312; sign the blockchain message, e.g., TMU 300 may sign blockchain transaction 312; and send the blockchain message to a blockchain network through a blockchain node connected to a blockchain network, e.g., TMU 300 may send blockchain transaction 312 to one of miner nodes 320. In some embodiments, generating and signing the blockchain transaction may be performed by an internet of things (IoT) device included in a shipment. For example, TMU 300 may be an IoT device.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

1. A method of enabling verification of a telemetry packet, the method comprising:
generating, by a controller in a device, a telemetry packet based on information received from at least one sensor;
generating, by the controller and based on information in the telemetry packet, a first blockchain message wherein data in the first blockchain message is usable for verifying at least one of:
authenticity and integrity of the information in the telemetry packet;
storing the telemetry packet by a server;
generating and signing by the controller a blockchain transaction to send the first blockchain message to a blockchain network; and
adding a block to a blockchain database, by a blockchain miner node associated with said network and based on the first blockchain message.

2. The method of claim 1, comprising:
using a key of the block to retrieve the first blockchain message; and
using data in the first blockchain message to verify at least one of: authenticity and integrity of the information in the telemetry packet.

3. The method of claim 1, wherein the blockchain transaction includes a cryptocurrency transaction between a wallet associated with the controller and a wallet associated with the server.

4. The method of claim 3, wherein the blockchain miner node is adapted to verify a blockchain transaction between the wallet associated with the controller and the wallet associated with the server.

5. The method of claim 1, comprising:
generating, by the server, a second blockchain message based on a status of the stored telemetry packet;
generating, by the server, a blockchain transaction to send the second blockchain message to a blockchain network; and
adding a block to a blockchain database, by the blockchain miner node and based on the second blockchain message.

6. The method of claim 1, wherein generating the blockchain message includes:
encrypting information received from the at least one sensor to produce encrypted data; and
including the encrypted data in the blockchain message.

7. The method of claim 1, wherein the blockchain transactions is performed according to one of: bitcoin protocol and Ethereum protocol.

8. The method of claim 1, wherein the information included in the telemetry packet includes data related to at least one of: a location, a timestamp, an address, a temperature, light exposure, humidity, pressure, proximity and an acceleration.

9. The method of claim 1, wherein server stores blockchain ledger information.

10. The method of claim 1, wherein generating the second blockchain message is based on information in the telemetry packet and information obtained from at least one additional source.

11. The method of claim 1, wherein the tracking device includes at least one of: a long-range transceiver circuit adapted to communicate over a wide area network and a short-range transceiver adapted to communicate with remote units.

12. The method of claim 1, wherein generating the first blockchain message includes storing in the first blockchain message at least a portion of the telemetry packet.

13. A method of sending sensor information from a device comprising:
reading, by a controller in the device, sensor information from a sensor;
generating, by the controller, a blockchain message based on the sensor information;
signing, by the controller, the blockchain message;
sending, by the controller, the message to a blockchain node within a blockchain network; and
adding a block to a blockchain database, by a blockchain miner node associated with said network and based on the blockchain message.

14. The method of claim 13, wherein said sensor is one of: a temperature sensor, a pressure sensor, a light exposure sensor, a proximity sensor, a humidity sensor and a sensor adapted to read a bar-code or a QR code.

15. The method of claim 13, wherein the blockchain network is one of: a Bitcoin network, an Ethereum network, a Ripple network and a Hyperledger network.

16. The method of claim 13, wherein the blockchain message causes execution of a smart-contract process, the smart-contract process including comparing data in the blockchain message to at least one predefined criterion.

17. A method comprising:
defining a smart contract related to a shipment, the smart contract including at least one constraint;
generating and signing a blockchain transaction, by a controller in a device, the blockchain transaction including information related to the shipment;
determining, based on the blockchain transaction and based on the smart contract whether or not the at least one constraint was breached; and
if the constraint was breached then performing an action defined in the smart contract.

18. The method according to claim 17, wherein said action involves a financial transaction involving an entity related to the shipment.

19. The method according to claim 17, further comprising reading information from a sensor in the device and including the information in the blockchain transaction.

20. A system comprising:
a memory;
a controller included in a shipment, the controller configured to:
read sensor information from a sensor;
generate a blockchain message based on the sensor information;
sign the blockchain message; and
send the blockchain message to a blockchain network through a blockchain node connected to a blockchain network.
